(19) United States
(12) Patent Application Publication
(10) Pub. No.: US 2017/0372123 A1
(43) Pub. Date: Dec. 28, 2017

(54) FINGERPRINT SENSOR MODULE ASSEMBLY INTEGRATED WITH COVER WINDOW FOR ELECTRONIC DEVICE

(71) Applicant: Crucialtec Co., Ltd., Asan-si (KR)

(72) Inventors: Jong Uk KIM, Hwaseong-si (KR); San KIM, Seongnam-si (KR); Woo Young CHOI, Seoul (KR)

(21) Appl. No.: 15/534,901

(22) PCT Filed: Dec. 11, 2015
(86) PCT No.: PCT/KR2015/013626

§ 371 Date: Jun. 9, 2017

(30) Foreign Application Priority Data
Dec. 11, 2014 (KR) 10-2014-0178274
Dec. 11, 2015 (KR) 10-2015-0177271

(51) Int. Cl. G06K 9/00; G06F 3/041

(52) U.S. Cl. CPC G06K 9/00087; G06K 9/0008; G06K 9/00053; G06F 3/0412; G06F 3/0416; G06K 9/0002

(57) ABSTRACT

The present invention provides a fingerprint sensor module assembly integrated with a cover window for an electronic device. The fingerprint sensor module assembly, according to one embodiment of the present invention, comprises: the cover window; a fingerprint sensor module; and an adhesion part. The cover window is disposed on a front surface of the electronic device. An image is generated from a display module and displayed on the cover window. The fingerprint sensor module is coupled to a seating part which is disposed on a lower surface of the cover window. The fingerprint sensor module comprises a fingerprint sensor having a sensing unit for sensing fingerprints; and a substrate electrically connected to the fingerprint sensor. The adhesion part is disposed between the seating part and the fingerprint sensor module and configured to fix the fingerprint sensor module in the seating part.

### CROSS-REFERENCE TO RELATED APPLICATIONS

This application is the National Stage Entry of International Patent Application No. PCT/KR2015/013626, filed on Dec. 11, 2015, and claims priority from and the benefit of Korean Patent Application No. 10-2014-0178274, filed on Dec. 11, 2014, and Korean Patent Application No. 10-2015-0177271, filed on Dec. 11, 2015, each of which is incorporated by reference for all purposes as if fully set forth herein.

### BACKGROUND

### Field

Exemplary embodiments of the present invention relates to a fingerprint sensor module assembly integrated with a cover window for an electronic device, and more particularly, to a fingerprint sensor module assembly integrated with a cover window for an electronic device which has a simple appearance such that an aesthetic sense of a design and waterproofing thereof can be improved.

### Discussion of the Background

Recently, with an increase of public interest in portable electronic devices such as smartphones or tablet PCs, research and development in the related technology fields is actively progressing.

In many cases, a portable electronic device has an embedded touch screen integrated with a display, which is a display device, as one of input devices for receiving specific commands from a user. In addition, the portable electronic device may include various function keys or soft keys as input devices other than the touch screen.

Such function keys or soft keys can operate as home keys. For example, the function keys or soft keys can operate as back keys which exit a running application to return to an initial screen or to return a user interface to a previous level, or operate as menu keys which call frequently used menus. The function keys or soft keys can be implemented by a method of sensing capacitance of a conductor, a method of sensing an electromagnetic wave of an electromagnetic pen, or a hybrid method in which both of these methods are implemented, and can also be implemented as physical buttons.

Recently, as the use of portable electronic devices has rapidly expanded to services requiring security, biometric sensors which are capable of measuring biometric information for high security have been increasingly installed in the portable electronic devices.

The biometric information includes fingerprints, blood vessels of the back of a hand, voices, irises, and the like. Fingerprint sensors can be widely used as the biometric sensors.

The fingerprint sensor is a sensor for sensing a fingerprint of a human being. By performing a user registration or authentication procedure through the fingerprint sensor, data stored in the portable electronic devices can be protected and security incidents may be prevented.

Since the fingerprint sensor can be manufactured in the form of a module including peripheral parts or structures and can be implemented to be integrated into a physical function key, the fingerprint sensor can be effectively mounted on various electronic devices.

Recently, utilization of the fingerprint sensor has being gradually increased. For example, a navigation function for performing manipulation of a pointer such as a cursor is integrated with the fingerprint sensor and this type of fingerprint sensor is referred to as a biometric track pad (BTP).

Types of fingerprint sensors include a capacitive type, an optical type, an ultrasonic type, a thermal sensing type, and a non-contact type. Capacitive fingerprint sensors having excellent sensitivity have been widely used recently since they are robust against external environment change and are excellent in compatibility with portable electronic devices.

FIG. 1 is a view illustrating an exemplary electronic device on which a conventional fingerprint sensor module is mounted, and FIG. 2 is a cross-sectional view taken along line A-A of FIG. 1.

As illustrated in FIGS. 1 and 2, a button hole 21 is disposed to pass through a cover window 20 of a conventional electronic device 10, and a fingerprint sensor module 30 is installed in the button hole 21.

The fingerprint sensor module 30 includes a fingerprint sensor 32 having a sensing unit 31 and a substrate 33 on which the fingerprint sensor 32 is mounted. A layer 34 including a color layer, a protective layer, and the like, is disposed on an upper surface of the fingerprint sensor 32. Generally, the fingerprint sensor module 30 coupled to the button hole 21 is mounted so that an upper surface 35 of the layer 34 has a height similar to an upper surface 22 of the cover window 20.

Since each manufacturer manufactures electronic devices having various thicknesses, fingerprint sensor modules having various heights suitable for such electronic devices are required. To this end, a method of adjusting a height of the fingerprint sensor 32 or a method of adjusting a thickness of the substrate 33 has been used. However, in order to increase the height of the fingerprint sensor 32 or the thickness of the substrate 33, there is a burden of a cost increase and difficulties in management due to the presence of substrates having various thicknesses.

Further, since the button hole 21 is disposed to pass through the cover window 20 so that the fingerprint sensor module 30 is mounted thereon, external moisture or moisture in the air may penetrate into a gap between the button hole 21 and the fingerprint sensor module 30. The penetration of external moisture or moisture in the air may cause a short circuit of an electrical path in the fingerprint sensor module 30 and cause the fingerprint sensor 32 to malfunction or break. Conventionally, a sealing agent 40 for preventing the penetration of external moisture or moisture in the air has been additionally provided, which leads to an increase in production costs and an additional process.

These problems may be commonly seen in fingerprint sensor modules disposed through various packaging methods such as a chip on board (COB) method, a quad flat package (QFP) method, a ball grid array (BGA) method, a wafer level package (WLP) method, and the like.

### SUMMARY

Exemplary embodiments of the present invention provide a fingerprint sensor module assembly integrated with a cover window for an electronic device with a simple appearance such that an aesthetic sense of a design and waterproofing thereof can be improved.

One aspect of the present invention provides a fingerprint sensor module assembly integrated with a cover window for an electronic device including the cover window disposed on a front surface of an electronic device, configured to display an image generated from a display module on the cover window, and having a seating part disposed on a lower surface of the cover window and facing an inside of the electronic device; a fingerprint sensor module including a fingerprint sensor having a sensing unit for sensing fingerprints and a substrate electrically connected to the fingerprint sensor, and located in the seating part; and an adhesion part disposed between the seating part and the fingerprint sensor module and configured to fix the fingerprint sensor module to the seating part.

The seating part may be disposed on the lower surface of the cover window.

The seating part may be formed in a groove shape to correspond to a shape of the fingerprint sensor and the fingerprint sensor may be mounted on and fixed to the seating part.

The seating part may be formed by an etching or cutting process.

The sensing unit and at least a part of the fingerprint sensor may be disposed in the seating part.

At least a part of the substrate may be additionally disposed in the seating part.

A thickness of the cover window between an upper surface of the cover window and an upper surface of the sensing unit may range from 200 μm to 300 μm.

The cover window may have a display area on which an image is displayed and a bezel area in which a print layer is disposed and an image is not displayed, and the seating part may be disposed in the bezel area.

An engraved or embossed pattern may be additionally disposed in an area corresponding to an upper side of the fingerprint sensor in the upper surface of the cover window which is exposed to a user.

An open area having a predetermined width may be disposed along an edge of the seating part on the lower surface of the cover window. A light-emitting unit configured to emit light toward the upper surface of the cover window through the open area, may be disposed under the cover window.

At least one light-emitting unit may be disposed on the substrate or a main substrate electrically connected to the fingerprint sensor module.

The cover window may have a display area on which an image is displayed and a bezel area in which a print layer is disposed and an image is not displayed, and the seating part may be disposed in the display area.

The cover window may be made from a material selected from glass, sapphire, zirconium and a transparent resin.

The cover window may further include a non-display part disposed independently of the cover window and the seating part may be disposed in the non-display part.

The non-display part may be made from a resin or a metal material.

The cover window may include a first cover window of which an upper surface is exposed to a user; an adhesive layer disposed on a lower surface of the first cover window; and a second cover window of which an upper surface is adhered to the lower surface of the first cover window by the adhesive layer, wherein the seating part may be disposed to pass through the second cover window.

A thickness of the second cover window may correspond to a height of the fingerprint sensor.

A color layer may be disposed on a surface of the seating part and the adhesion part may be disposed on the color layer.

According to one exemplary embodiment, since a fingerprint sensor is coupled to a seating part disposed on a lower surface of a cover window, a continuous surface can be disposed when viewed from an upper surface of the cover window so as to have a simple appearance and improve an aesthetic sense of a design thereof.

Further, according to one exemplary embodiment, since a cover window has a continuous surface without having the same button hole as that of a conventional cover window, the penetration of external moisture or moisture in the air can be structurally blocked and thus waterproofing can be improved.

Effects of exemplary embodiments are not limited to the above-described effects and all effects that can be inferred from the detailed description of the invention or composition of the invention described in the claims may be understood as being included therein.

### BRIEF DESCRIPTION OF THE DRAWINGS

FIG. 1 is a view illustrating an exemplary electronic device on which a conventional fingerprint sensor module is mounted.

FIG. 2 is a cross-sectional view taken along line A-A of FIG. 1.

FIG. 3 is a view illustrating an exemplary electronic device having a fingerprint sensor module assembly integrated with a cover window for an electronic device according to a first exemplary embodiment.

FIG. 4 is a plan view illustrating the fingerprint sensor module assembly integrated with a cover window for an electronic device according to the first exemplary embodiment.

FIG. 5 is a bottom view illustrating the fingerprint sensor module assembly integrated with a cover window for an electronic device according to the first exemplary embodiment.

FIG. 6 is an exploded perspective view of the fingerprint sensor module assembly integrated with a cover window for an electronic device according to the first exemplary embodiment.

FIG. 7 is a cross-sectional view taken along line B-B of FIG. 4.

FIGS. 8A, 8B, 8C and 8D illustrate cross-sectional views of examples of a coupling of a fingerprint sensor module and a seating part in the fingerprint sensor module assembly integrated with a cover window for an electronic device according to the first exemplary embodiment.

FIGS. 9 and 10 are cross-sectional views illustrating installation examples of the fingerprint sensor module assembly integrated with a cover window for an electronic device according to the first exemplary embodiment.

FIG. 11 is a plan view illustrating an example of an enlarged part of an electronic device having the fingerprint sensor module assembly integrated with a cover window for an electronic device according to the first exemplary embodiment o.

FIGS. 12A and 12B illustrate cross-sectional views of installation examples of a light-emitting unit taken along line C-C of FIG. 11.

FIGS. 13A, 13B, 14A, 14B, 15A and 15B are views illustrating examples of a formation of a surface of the cover window corresponding to an upper side of a fingerprint sensor in the fingerprint sensor module assembly integrated with a cover window for an electronic device according to the first exemplary embodiment.

FIG. 16 is a cross-sectional view illustrating an installation example of a fingerprint sensor module assembly integrated with a cover window for an electronic device according to a second exemplary embodiment o and an electronic device.

FIG. 17 is a plan view illustrating an exemplary cover window of a fingerprint sensor module assembly integrated with a cover window for an electronic device according to a third exemplary embodiment.

FIG. 18 is a plan view illustrating an exemplary cover window of a fingerprint sensor module assembly integrated with a cover window for an electronic device according to a fourth exemplary embodiment.

FIG. 19 is a perspective view illustrating a fingerprint sensor module assembly integrated with a cover window for an electronic device according to a fifth exemplary embodiment.

FIG. 20 is a perspective view illustrating a fingerprint sensor module of the fingerprint sensor module assembly integrated with a cover window for an electronic device according to the fifth exemplary embodiment of the present invention.

FIG. 21 is a cross-sectional view taken along line G-G of FIG. 19.

FIG. 22 is an exploded perspective view illustrating the fingerprint sensor module assembly integrated with a cover window for an electronic device according to the fifth exemplary embodiment.

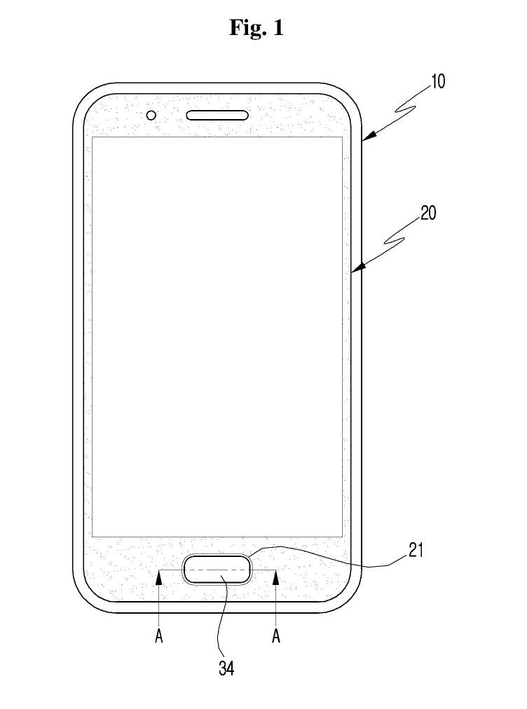

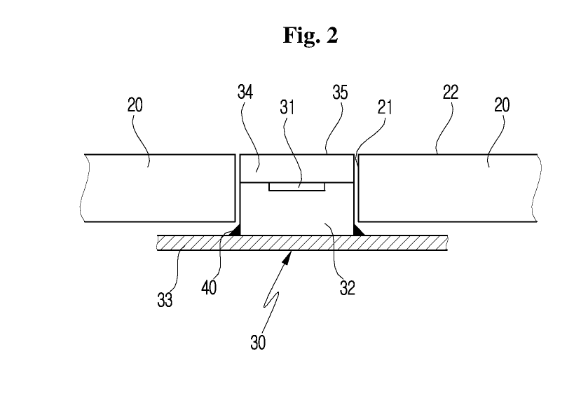

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. It should be understood that when an element is referred to as being “connected” or “coupled” to another element, the element can be directly connected or coupled to the other element or intervening elements may be present. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Hereinafter, exemplary embodiments of the present invention will be described with reference to the accompanying drawings. However, exemplary embodiments of the present invention may be implemented in several different forms, and are not limited to exemplary embodiments described herein. In addition, parts irrelevant to description are omitted in the drawings in order to clearly explain the present invention. Similar parts are denoted by similar reference numerals throughout this specification.

Throughout this specification, when a part is referred to as being “connected” to another part, the part may be “directly connected” or “indirectly connected” via an intervening part. Also, when a certain part “includes” a certain component, other components are not excluded from being included unless described otherwise stated, and other components may in fact be included.

Hereinafter, exemplary embodiments of the present invention will be described in detail with reference to the accompanying drawings.

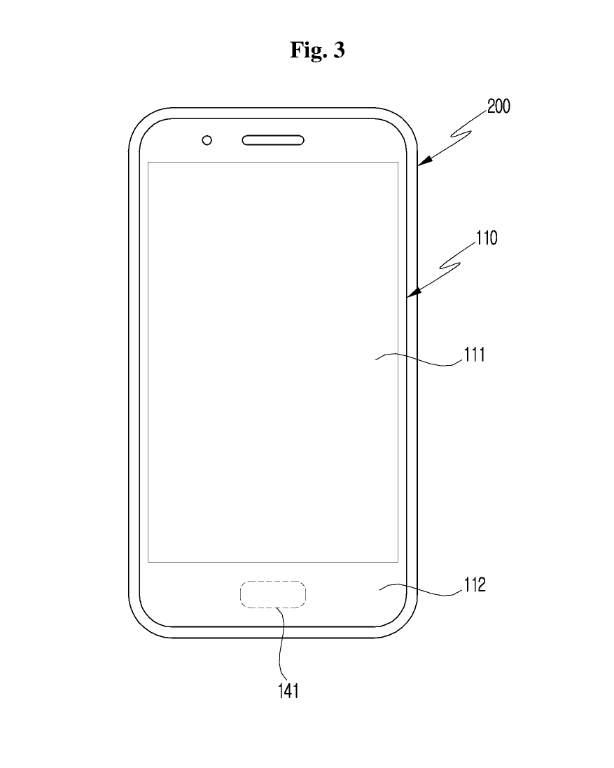

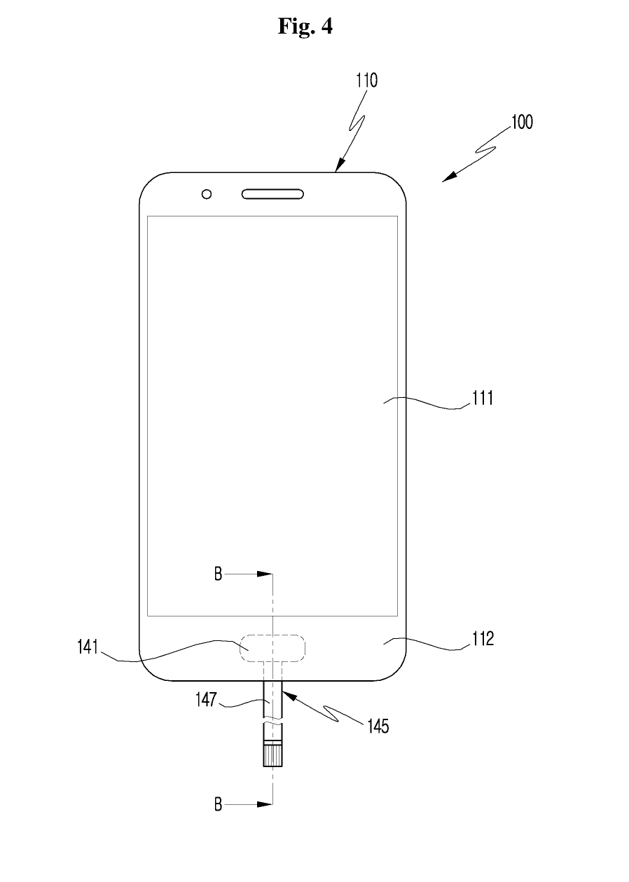

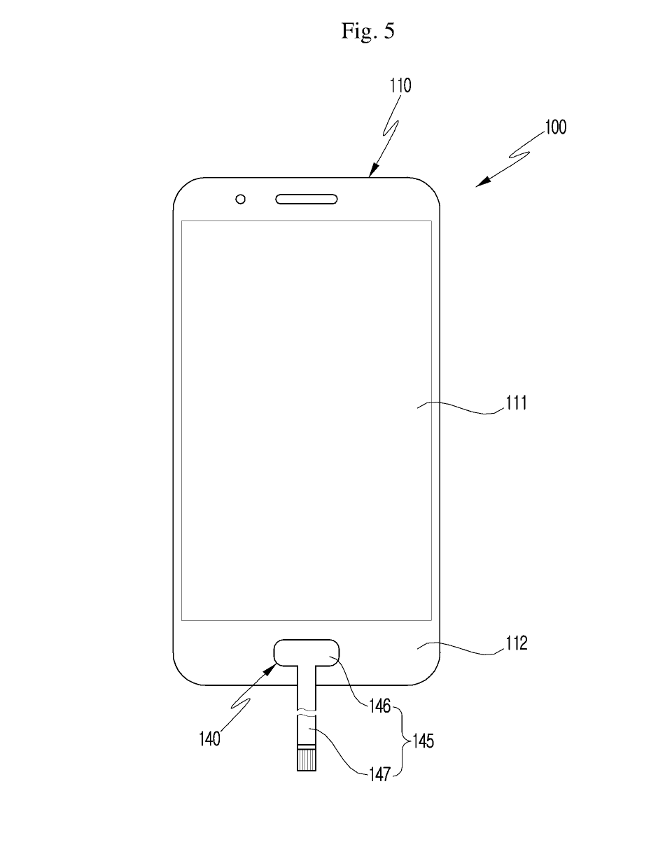

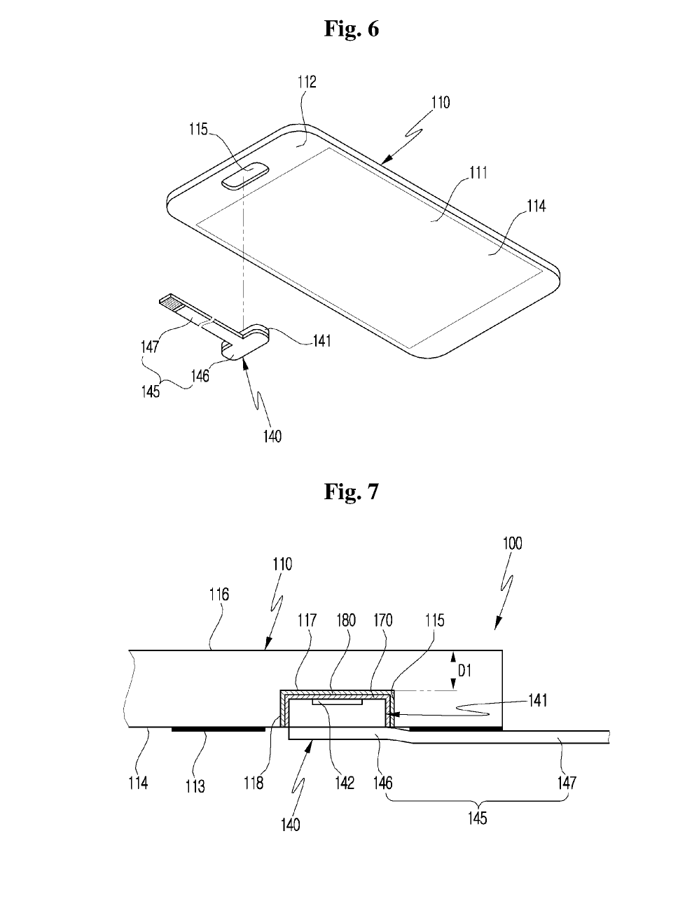

FIG. 3 is a view illustrating an exemplary electronic device having a fingerprint sensor module assembly integrated with a cover window for an electronic device according to a first exemplary embodiment, FIG. 4 is a plan view illustrating the fingerprint sensor module assembly integrated with a cover window for an electronic device according to the first exemplary embodiment, FIG. 5 is a bottom view illustrating the fingerprint sensor module assembly integrated with a cover window for an electronic device according to the first exemplary embodiment, FIG. 6 is an exploded perspective view of the fingerprint sensor module assembly integrated with a cover window for an electronic device according to the first exemplary embodiment, and FIG. 7 is a cross-sectional view taken along line B-B of FIG. 4.

As illustrated in FIGS. 3, 4, 5, 6, and 7, a fingerprint sensor module assembly 100 is integrated with a cover window for an electronic device according to the first exemplary embodiment. As illustrated in FIG. 7, the fingerprint sensor module assembly 100 may include a cover window 110, a fingerprint sensor module 140, and an adhesion part 170.

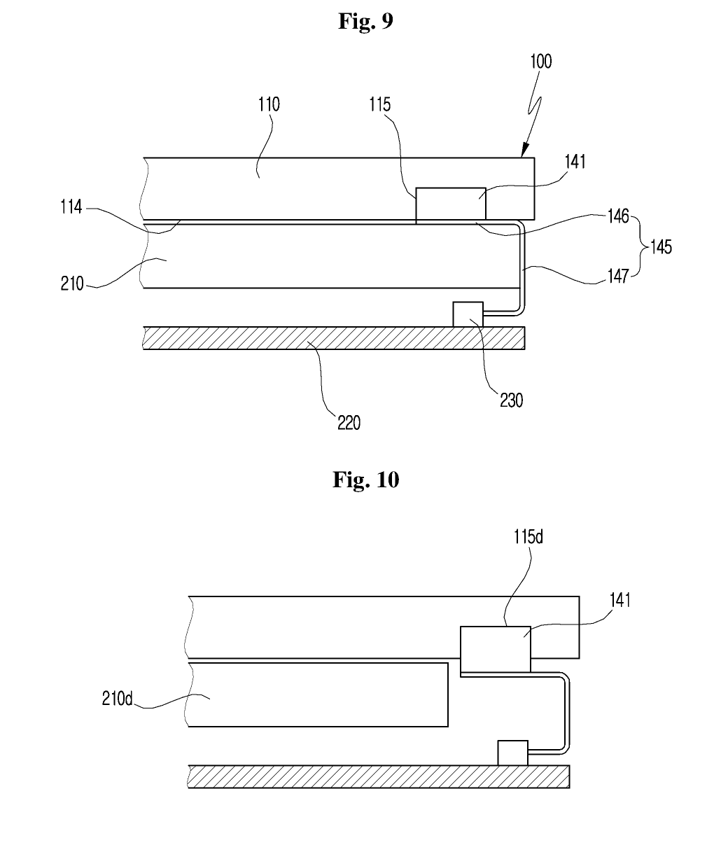

As illustrated in FIG. 9, the cover window 110 is disposed on a front surface of an electronic device 200 and configured such that an image generated from a display module 210 is transmitted and displayed thereon.

The cover window 110 may be made from a material selected from glass, sapphire, zirconium, and a transparent resin. When the cover window 110 is made from glass, various glass substrates such as a soda-lime glass substrate, an alkali-free glass substrate, a tempered glass substrate, and the like may be applied. The transparent resin may be an acrylic material or the like.

As illustrated in FIGS. 3, 4, 5 and 6, the cover window 110 may have a display area 111 on which an image is displayed and a bezel area 112 on which no image is displayed.

The bezel area 112 may be disposed by providing a print layer 113. When the cover window 110 is mounted on the electronic device 200, the print layer 113 may be disposed on a lower surface 114 of the cover window 110 facing an inside of the electronic device 200 or on an edge area of the cover window 110.

The fingerprint sensor module 140 may include a fingerprint sensor 141 and a substrate 145.

The fingerprint sensor 141 according to the exemplary embodiment may include various types. For example, a capacitive type, an optical type, an ultrasonic type, a thermal detection type, or a non-contact type of fingerprint sensor may be applied to the fingerprint sensor 141. Hereinafter, the fingerprint sensor 141 will be described as a capacitive type fingerprint sensor for convenience of description.

The fingerprint sensor 141 may have a sensing unit 142 which senses a fingerprint. The sensing unit 142 may be formed in various forms. For example, the sensing unit 142 may be arranged in an array form and may include sensing pixels having a sensing area. Further, the sensing unit 142 may include a plurality of line-type driving electrodes and receiving electrodes. Further, the sensing unit 142 may be disposed in an area-type having a plurality of image receiving units.

The sensing unit 142 may find a difference in capacitance due to a height difference caused by shapes of a ridge and a valley of a fingerprint of a user's finger, and may scan an image of the fingerprint to generate a fingerprint image. The sensing unit 142 may scan the image of the fingerprint to generate the fingerprint image when the user's finger is touched thereto and when the user's finger moves in a state in which the user's finger is in contact therewith.

Further, the sensing unit 142 may have a fingerprint sensing function for sensing a fingerprint and a pointer manipulation function, and thus the fingerprint sensor 141 may be implemented as a biometric track pad (BTP).

In addition, the sensing unit 142 may have a function of tracking a position of the user's finger. That is, the sensing unit 142 may sense input information or static electricity according to the movement of the user's finger or whether the user's finger is approaching, and may have a pointer manipulation function for moving a pointer such as a cursor on the basis of the movement.

Further, the fingerprint sensor 141 may be electrically connected to the substrate 145. The electrical connection between the fingerprint sensor 141 and the substrate 145 may be made by various methods, for example, by a surface mount technology (SMT) method or the like.

Further, the fingerprint sensor 141 may be disposed through various packaging methods such as a chip on board (COB) method, a quad flat package (QFP) method, a ball grid array (BGA) method, a wafer level package (WLP) method, a through-silicon via (TSV) method, and the like.

The substrate 145 may have a mounting part 146 on which the fingerprint sensor 141 is mounted and an extension part 147 which extends from the mounting part 146. The substrate 145 may be a flexible printed circuit board (FPCB). As illustrated in FIG. 9, the extension part 147 may be connected to a connector 230 which is disposed on a main substrate 220 of the electronic device 200.

The cover window 110 may have a seating part 115 which is disposed on the lower surface 114 facing the inside of the electronic device 200. In the first exemplary embodiment, the seating part 115 may be disposed in the bezel area 112.

Further, the seating part 115 may be disposed on a surface of the lower surface 114 of the cover window 110 or may be disposed in the cover window 110 to have a groove shape.

When the seating part 115 is disposed to have a groove shape, the seating part 115 may be disposed to correspond to a shape of the fingerprint sensor 141. Hereinafter, the seating part 115 disposed to have a groove shape will be described for convenience of description.

When the seating part 115 is disposed to have a groove shape, the seating part 115 may be disposed by a method such as etching, cutting, or the like. Such a method may be appropriately selected according to a material of the cover window 110. For example, when the cover window 110 is made from glass, the seating part 115 may be disposed by a method such as etching or computer numerical control (CNC) machining. As the etching method, either dry etching or wet etching may be performed or a method in which dry etching and wet etching are alternately performed may be used. Further, when the cover window 110 is made from a synthetic resin such as plastic or the like, the seating part 115 may be molded at a time at which the cover window is molded.

The fingerprint sensor module 140 may be coupled to the seating part 115, and the adhesion part 170 may be disposed on the seating part 115 so that the fingerprint sensor module 140 is firmly coupled to the seating part 115.

Here, a color layer 180 may be disposed on a surface of the seating part 115. The color layer 180 may express a color toward an upper surface 116 of the cover window 110 along with the print layer 113 which is disposed in the bezel area 112 of the cover window 110.

The color layer 180 may be disposed only on a bottom surface 117 of the seating part 115, or may also be disposed on a side surface 118 of the seating part 115. Further, the color layer 180 may have the same color as or a different color from the print layer 113.

The adhesion part 170 may be disposed on the color layer 180. That is, the color layer 180 is disposed on the seating part 115, and then the adhesion part 170 may be disposed on the color layer 180.

The adhesion part 170 may be formed in various forms such as a film form, a liquid form, a powder form, and the like. The adhesion part 170 may be appropriately selected according to a type of the fingerprint sensor. For example, the adhesion part 170 preferably has a high dielectric constant and adhesive strength and a low viscosity when the fingerprint sensor 141 is a capacitive type fingerprint sensor, and the adhesion part 170 is preferably non-conductive so as not to affect sound waves when the fingerprint sensor 141 is an ultrasonic type fingerprint sensor.

The adhesion part 170 may be disposed on both of the bottom surface 117 and the side surface 118 of the seating part 115 or may be disposed first on the bottom surface 117 of the seating part 115 to fix a position of the fingerprint sensor 141 and then be additionally disposed on the side surface 118 of the seating part 115. That is, the adhesion part 170 may be disposed in a space between an outer surface of the fingerprint sensor 141 and the side surface 118 of the seating part 115, to mold and fix the fingerprint sensor 141, which is mounted on the seating part 115.

The sensing unit 142 and at least a part of the fingerprint sensor 141 may be disposed in the seating part 115.

A thickness D1 of the cover window 110 between the upper surface 116 of the cover window 110 and an upper surface of the sensing unit 142 may range from 200 μm to 300 μm. The thickness D1 is derived in consideration of strength of the cover window 110 and sensing sensitivity of the fingerprint sensor 141. When the thickness D1 is less than 200 μm, the cover window 110 may not provide sufficient strength, and when the thickness D1 is more than 300 μm, the sensing sensitivity of the sensing unit 142 may be lowered.

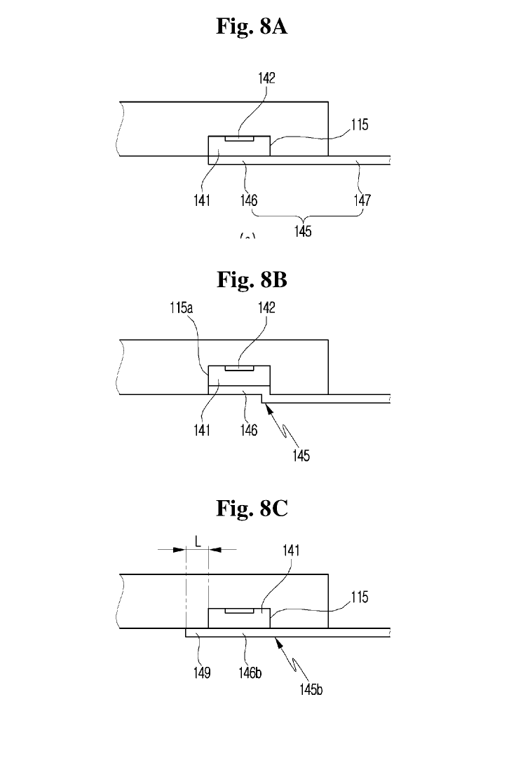

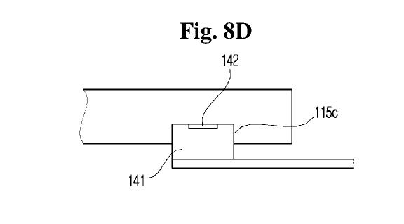

FIGS. 8A, 8B, 8C and 8D illustrate cross-sectional views of examples of a coupling of the fingerprint sensor module and the seating part in the fingerprint sensor module assembly integrated with a cover window for an electronic device according to the first exemplary embodiment.

Referring to FIG. 8A, the seating part 115 may be formed to correspond to a shape of the fingerprint sensor 141, and the fingerprint sensor 141 may be mounted on and fixed to the seating part 115. That is, both of the sensing unit 142 and the fingerprint sensor 141 may be mounted on the seating part 115. The mounting part 146 and the extension part 147 of the substrate 145 may be disposed outside the seating part 115.

Referring to FIG. 8B, at least a part of the substrate 145 may be located in a seating part 115a. Here, the part of the substrate 145 which is disposed in the seating part 115a may be the mounting part 146. That is, both of the fingerprint sensor 141 including the sensing unit 142 and the mounting part 146 of the substrate 145 may be mounted in the seating part 115a.

Referring to FIG. 8C, a mounting part 146b of a substrate 145b may be formed to have a greater area than the fingerprint sensor 141. Therefore, when the fingerprint sensor 141 is totally mounted in the seating part 115, a part 149 of the mounting part 146b may extend to the outside of the fingerprint sensor 141. In this case, a length L of the part 149 of the mounting part 146b which extends to the outside of the fingerprint sensor 141 is not particularly limited.

Further, referring to FIG. 8D, the sensing unit 142 and an upper part of the fingerprint sensor 141 may be disposed in a seating part 115c. That is, according to the exemplary embodiment, the sensing unit 142 and at least a part of the fingerprint sensor 141 may be disposed in the seating part 115c.

As described above, according to the exemplary embodiment, since the fingerprint sensor 141 is coupled to the seating part 115 which is disposed on the lower surface 114 of the cover window 110, the upper surface 116 of the cover window 110 may be continuously disposed so as to have a simple appearance and improve an aesthetic sense of a design. Further, according to the exemplary embodiment, since the cover window 110 does not have the same button hole as that of a conventional cover window and has a continuous surface, penetration of external moisture or moisture in the air may be structurally blocked, and thus waterproofing can be improved.

FIGS. 9 and 10 are cross-sectional views illustrating installation examples of the fingerprint sensor module assembly integrated with a cover window for an electronic device according to the first exemplary embodiment.

First, as illustrated in FIG. 9, the fingerprint sensor 141 may be mounted and fixed to the seating part 115 of the cover window 110. The mounting part 146 of the substrate 145 may be disposed to be in close contact with the lower surface 114 of the cover window 110. In this case, since the substrate 145 is disposed to have a sufficiently thin thickness, the display module 210 may be disposed to be close to or in close contact with a lower side of the fingerprint sensor module assembly 100 integrated with a cover window for an electronic device. The cover window 110 and the display module 210 may be attached to each other by an adhesive (not illustrated) or the like.

Here, the display module 210 may include a touch screen panel (not illustrated), and the main substrate 220 of the electronic device may be disposed below the display module 210. The connector 230 may be disposed on the main substrate 220.

In the fingerprint sensor module assembly integrated with a cover window for an electronic device according to the exemplary embodiment, the extension part 147 of the substrate 145 may extend to the outside of the display module 210 and may be connected to the connector 230 of the main substrate 220 in a state in which the fingerprint sensor 141 is coupled to the seating part 115. Such a connection method may be applied to all of a structure in which the touch screen panel is disposed inside the display module 210 and a structure in which the touch screen panel is disposed above the display module 210.

As illustrated in FIG. 10, a part of the fingerprint sensor 141 may protrude outside a seating part 115d, and in this case, a display module 210d may be disposed so as not to be disposed below the fingerprint sensor 141. For example, the display module 210d may be disposed to have a shorter length than the display module 210 described in FIG. 9 such that overlapping between the display module 210d and the fingerprint sensor 141 may not occur.

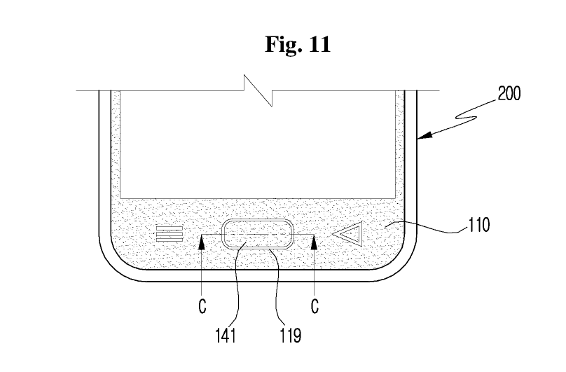

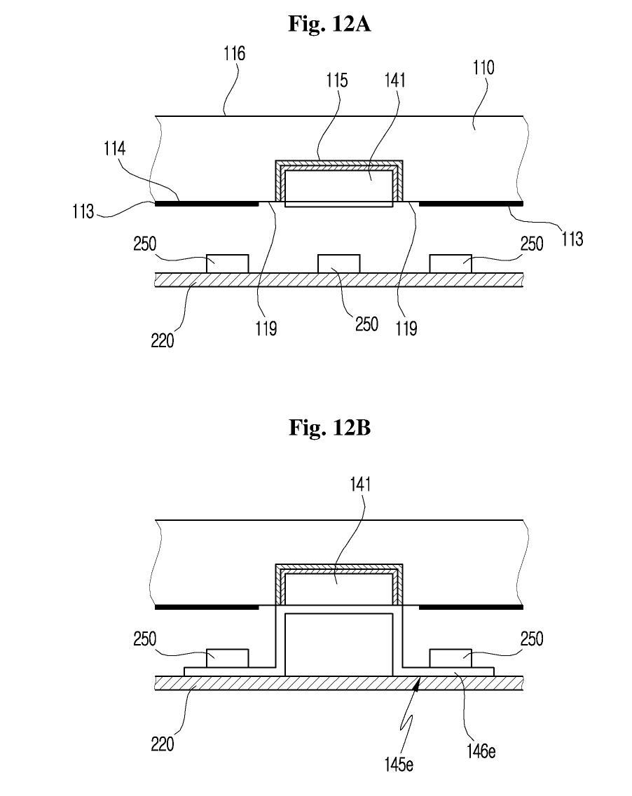

FIG. 11 is a plan view illustrating an example of an enlarged part of an electronic device having the fingerprint sensor module assembly integrated with a cover window for an electronic device according to the first exemplary embodiment. FIGS. 12A and 12B illustrate cross-sectional views of installation examples of a light-emitting unit taken along line C-C of FIG. 11.

As illustrated in FIGS. 11, 12A and 12B, an open area 119 having a predetermined width may be disposed along an edge of the seating part 115 on the lower surface 114 of the cover window 110. Here, he open area 119 may be a surface in which the print layer 113, which is provided on the lower surface 114 of the cover window 110, is not disposed along the edge of the seating part 115.

Light-emitting units 250 may be disposed under the cover window 110.

Referring to FIG. 12A, one or more light-emitting units 250 may be disposed on the main substrate 220 of the electronic device 200, and the light-emitting units 250 may be mounted on the main substrate 220 to be located around the fingerprint sensor 141. The light-emitting units 250 may use a light-emitting diode (LED) as a light source and include a plurality of light sources such as a white LED, a red LED, a green LED, and the like in order to emit light of various colors.

The light-emitting units 250 may appropriately use a light source having directivity toward an upper surface thereof to emit light in an upward direction or a light source having directivity toward a side surface thereof to emit light in a lateral direction.

Light emitted from the light-emitting units 250 may be emitted toward the upper surface 116 of the cover window 110 through the open area 119. The light emitted toward the upper surface 116 of the cover window 110 through the open area 119 may represent a shape of the open area 119. This shape may serve as an indicator which indicates a position of the fingerprint sensor 141.

That is, in the exemplary embodiment, since an upper side of the fingerprint sensor 141 is covered by the cover window 110, it may be difficult for a user to recognize the position of the fingerprint sensor 141. The light emitted through the open area 119 may inform the user of the position of the fingerprint sensor 141 and may effectively inform the user of the position of the fingerprint sensor 141 especially at night.

Although the open area 119 is illustrated as having a track shape in FIG. 11, the track shape is only exemplary. The open area 119 is not limited to the case in which the open area 119 is disposed along the edge of the seating part 115 and may be formed in various shapes.

Further, the light-emitting units 250 may emit light of various colors by a combination of light sources, and may emit light of different colors according to a function and allow the user to recognize a corresponding function, state, and the like by the color of the light.

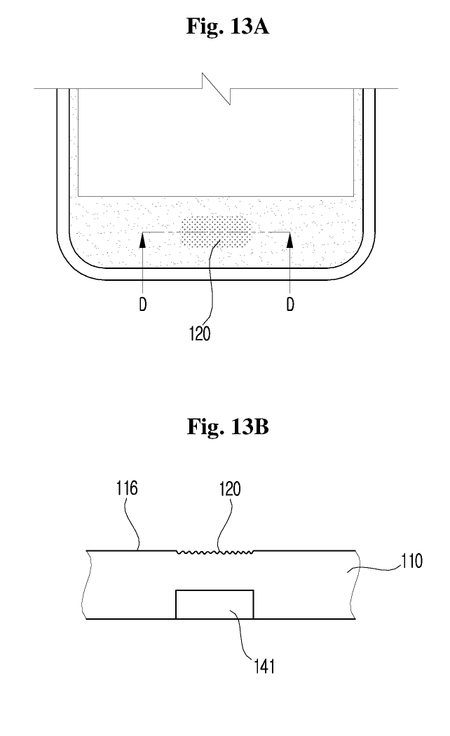

In addition, the open area 119 may be used in combination with various patterns to be described below with reference to FIGS. 13A, 13B, 14A, 14B, 15A and 15B.

Referring to FIG. 12B, one or more light-emitting units 250 may be disposed on a substrate 145e. The light-emitting units 250 may be disposed on a mounting part 146e of the substrate 145e, and to this end, the mounting part 146e may extend to the outside of the fingerprint sensor 141.

In addition, a vibrating unit (not illustrated) may also be disposed on at least one of the substrate 145e and the main substrate 220, and may generate a specific vibration in conjunction with the light-emitting units 250 and allow the user to recognize a corresponding function, state, and the like.

FIGS. 13A, 13B, 14A, 14B, 15A and 15B are views illustrating examples of a formation of a surface of the cover window corresponding to an upper side of a fingerprint sensor in the fingerprint sensor module assembly integrated with a cover window for an electronic device according to the first exemplary embodiment.

As illustrated in FIGS. 13A, 13B, 14A, 14B, 15A and 15B, an engraved or embossed pattern may further be disposed in an area corresponding to the upper side of the fingerprint sensor 141 disposed in the upper surface 116 of the cover window 110 which is exposed to the user.

First, FIG. 13A is a plan view illustrating the cover window, and FIG. 13B is a cross-sectional view taken along line D-D. Referring to FIGS. 13A and 13B, an engraved pattern 120 may be disposed in the area corresponding to the upper side of the fingerprint sensor 141 in the upper surface 116 of the cover window 110. The engraved pattern 120 may have a geometric shape or the like.

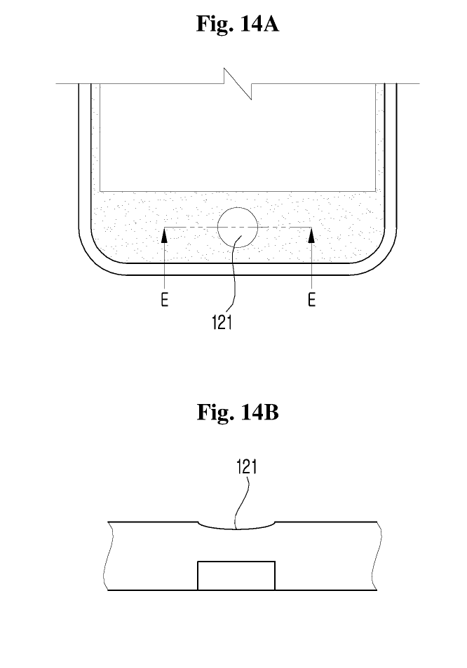

Further, FIG. 14A is a plan view illustrating the cover window and FIG. 14B is a cross-sectional view taken along line E-E. Referring to FIGS. 14A and 14B, an engraved pattern 121 may be disposed to have a groove shape.

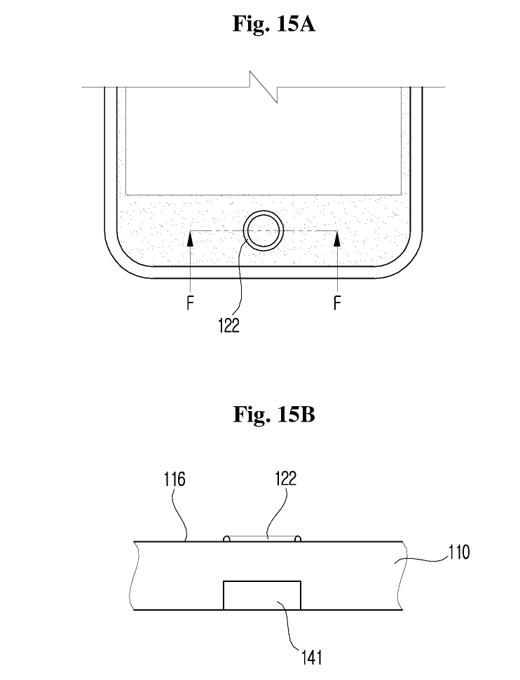

FIG. 15A is a plan view illustrating the cover window and FIG. 15B is a cross-sectional view taken along line F-F. Referring to FIGS. 15A and 15B, an embossed pattern 122 may be disposed in the area corresponding to the upper side of the fingerprint sensor 141 in the upper surface 116 of the cover window 110. Here, the embossed pattern 122 may be disposed to avoid a fingerprint sensing area. Although a ring shape which protrudes along the edge of the fingerprint sensor 141 is illustrated as the embossed pattern 122 in FIGS. 15A and 15B, the ring shape is only exemplary and the present invention is not limited thereto.

The embossed pattern 122 may be in a state in which the embossed pattern 122 does not normally protrude, and may be disposed to protrude in a specific state, for example, when the user's finger touches the fingerprint sensor 141. The embossed pattern 122 may be implemented by a component which is separately disposed on the upper surface of the cover window 110 and the component may include a component having a polymeric material of which a shape may be deformed to form the embossed pattern 122.

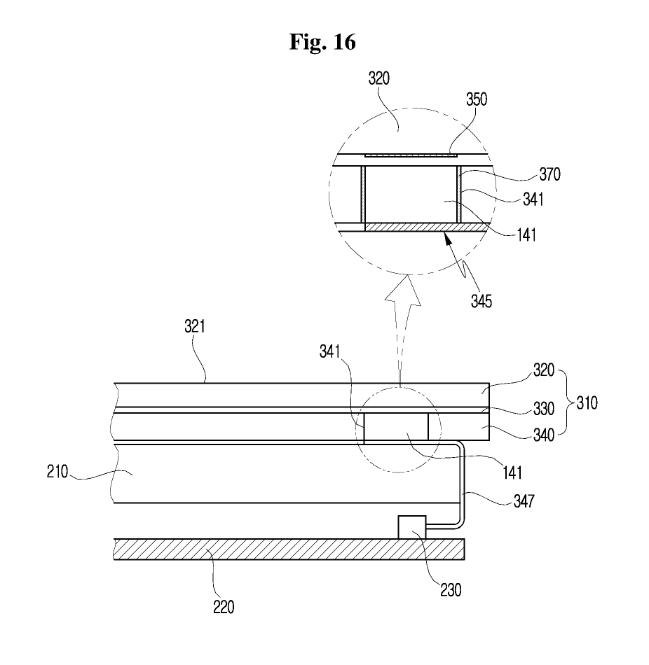

FIG. 16 is a cross-sectional view illustrating an installation example of a fingerprint sensor module assembly integrated with a cover window for an electronic device according to a second exemplary embodiment and an electronic device. In the second exemplary embodiment, a cover window may have a different configuration. Since the other components are the same as those of the first exemplary embodiment described above, descriptions thereof will be omitted.

As illustrated in FIG. 16, a cover window 310 may include a first cover window 320, an adhesive layer 330, and a second cover window 340.

An upper surface 321 of the first cover window 320 may be a surface exposed to a user, and the adhesive layer 330 may be disposed on a lower surface of the first cover window 320.

The adhesive layer 330 may be formed by coating or formed in a film form to be attached. For example, an optically clear resin (OCR) or an optically clear adhesive (OCA) may be used as the adhesive layer 330.

The second cover window 340 may have an upper surface, which is attached to the adhesive layer 330 and adhered to the lower surface of the first cover window 320, and the second cover window 340 and the first cover window 320 may be made from the same material.

A seating part 341 may be disposed in the second cover window 340, and in this case, the seating part 341 may be disposed to pass through the second cover window 340.

A color layer 350 may be disposed at a position corresponding to an upper part of the fingerprint sensor 141 in the lower surface of the first cover window 320, and may also be disposed on a side surface of the seating part 341 of the second cover window 340.

Further, an adhesion part 370 may also be disposed between the side surface of the seating part 341 of the second cover window 340 and a side surface of the fingerprint sensor 141.

A thickness of the second cover window 340 may correspond to a thickness of the fingerprint sensor 141. In this case, since the seating part 341 may be disposed to pass through the second cover window 340, there is an advantage in that a process of matching a depth of the seating part 341 may be omitted.

An extension part 347 of a substrate 345, on which the fingerprint sensor 141 coupled to the seating part 341 is mounted, may extend to the outside of the display module 210 and may be connected to the connector 230 of the main substrate 220. Such a connection method may be applied to a structure in which a touch screen panel (not illustrated) may be disposed inside the display module 210 or a structure in which a touch screen panel (not illustrated) is disposed above the display module 210.

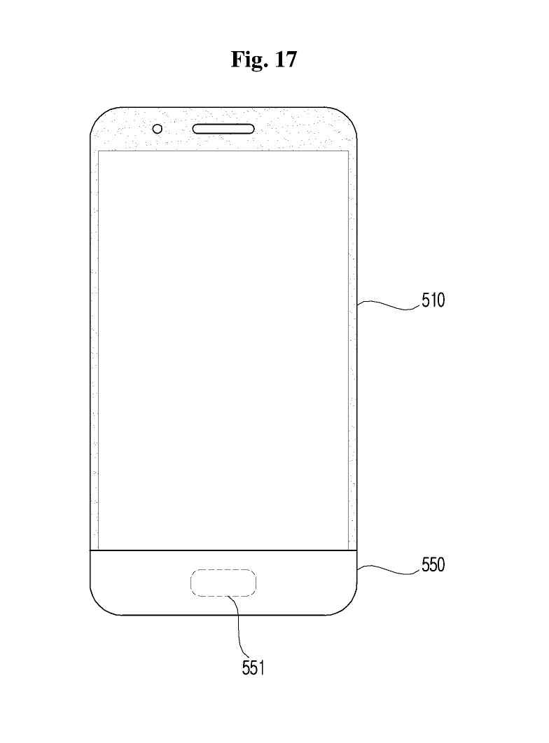

FIG. 17 is a plan view illustrating an exemplary cover window of a fingerprint sensor module assembly integrated with a cover window for an electronic device according to a third exemplary embodiment.

As illustrated in FIG. 17, a cover window 510 according to the exemplary embodiment may further include a non-display part 550 disposed independently of the cover window 510. Also, a seating part 551 may be disposed in the non-display part 550.

In the present exemplary embodiment, the non-display part 550 may be made from a metal material or a synthetic resin such as plastic.

The seating part 551 may be disposed through machining after the non-display part 550 is disposed, or may be disposed at a time at which the non-display part 550 is molded.

In the exemplary embodiment, since the non-display part 550 may be disposed to be opaque due to characteristics of a material forming the non-display part 550, the print layer 113 illustrated in FIG. 7 in the first exemplary embodiment described above may be omitted.

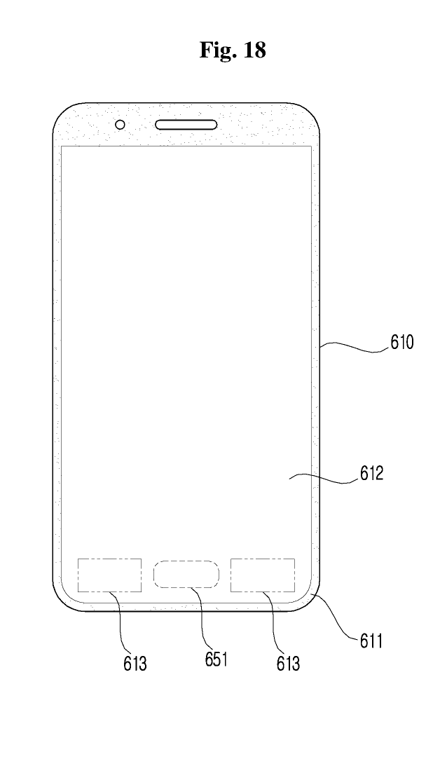

FIG. 18 is a plan view illustrating an exemplary cover window of a fingerprint sensor module assembly integrated with a cover window for an electronic device according to a fourth exemplary embodiment.

As illustrated in FIG. 18, a bezel area 611 of a cover window 610 according to the present exemplary embodiment may be disposed to have a smaller area than the bezel area 112 illustrated in FIG. 4 of the first exemplary embodiment described above. That is, when the same sized cover window is used, a display area 612 of the cover window 610 according to the present exemplary embodiment may be formed to have a greater area than the display area 111 illustrated in FIG. 4 of the first exemplary embodiment described above.

A seating part 651 may be disposed in the display area 612.

In the present exemplary embodiment, since the seating part 651 is disposed in the display area 612, a fingerprint sensor (not illustrated) may be disposed in the display area 612. Therefore, an image may be displayed in both side areas 613 of the fingerprint sensor, and thus it is possible to produce a wider variety of screens.

Referring to FIG. 9, in the present exemplary embodiment, an image generated from the display module 210 may be understood as being displayed on a lower part (i.e., the display area 612) of the cover window 110 except for a part in which the fingerprint sensor 141 is disposed.

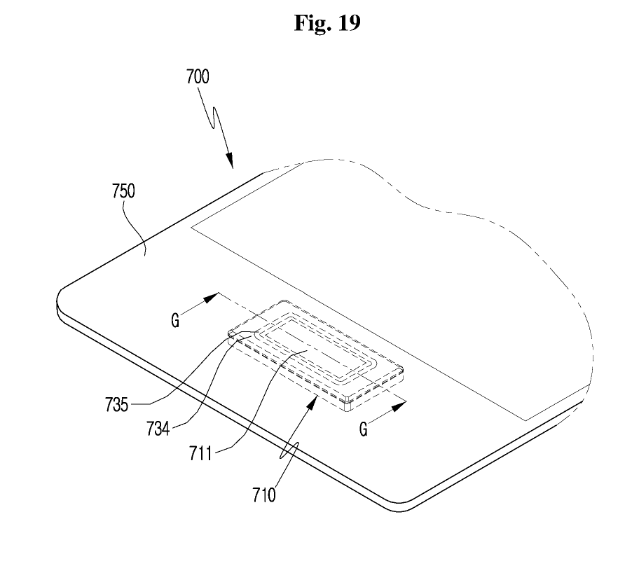

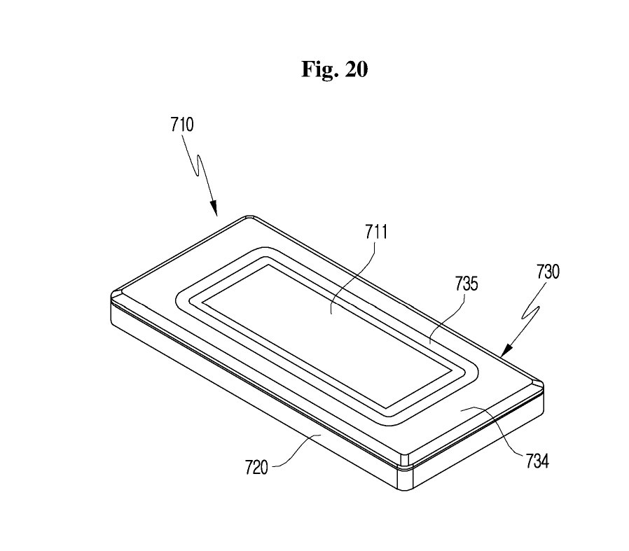

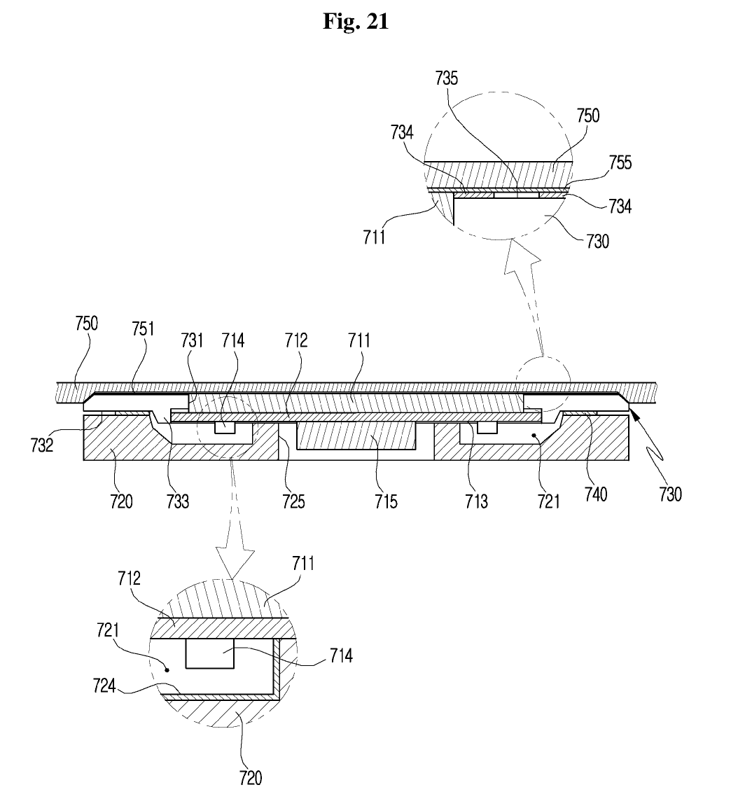

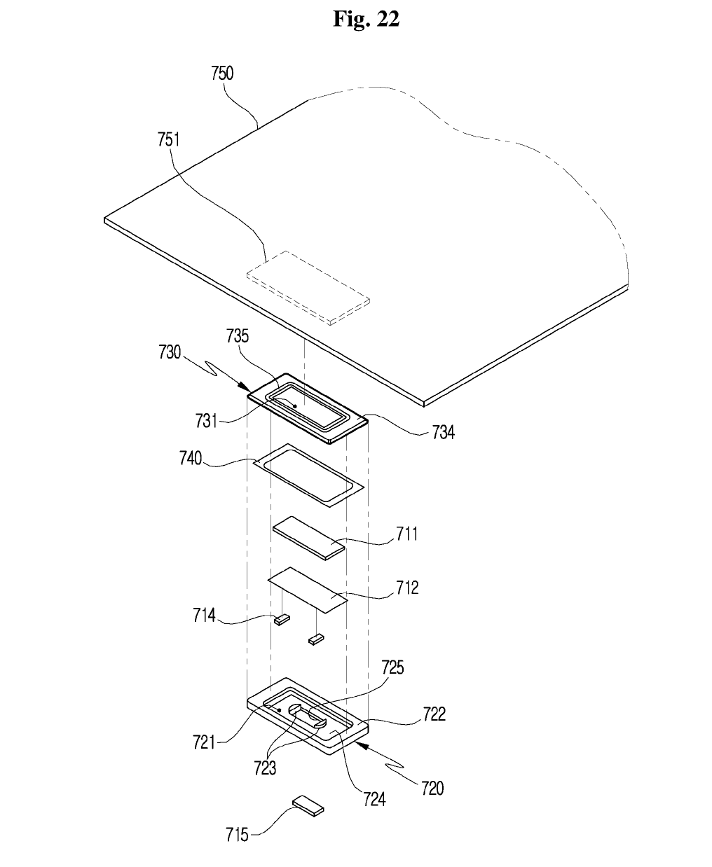

FIG. 19 is a perspective view illustrating a fingerprint sensor module assembly integrated with a cover window for an electronic device according to a fifth exemplary embodiment. FIG. 20 is a perspective view illustrating a fingerprint sensor module of the fingerprint sensor module assembly integrated with a cover window for an electronic device according to the fifth exemplary embodiment. FIG. 21 is a cross-sectional view taken along line G-G of FIG. 19. FIG. 22 is an exploded perspective view illustrating the fingerprint sensor module assembly integrated with a cover window for an electronic device according to the fifth exemplary embodiment. In the exemplary embodiment, the fingerprint sensor module may have a different configuration. Since the other components are the same as those of the first exemplary embodiment described above, descriptions thereof will be omitted.

As illustrated in FIGS. 19 to 22, a fingerprint sensor module 710 of a fingerprint sensor module assembly 700 integrated with a cover window for an electronic device according to the exemplary embodiment may include a fingerprint sensor 711, a substrate 712, a base 720, and a cover 730.

Here, all of the content related to the fingerprint sensor of the first exemplary embodiment may be applied to the fingerprint sensor 711.

The fingerprint sensor 711 may be mounted on the substrate 712, and in the exemplary embodiment, the substrate 712 may be a rigid printed circuit board (PCB).

The base 720 may include a groove 721, a reflective part 724, and a through part 725.

As illustrated in FIG. 22, the groove 721 may be disposed to be recessed on an upper surface 722 of the base 720. Further, supporting units 723 may be disposed near a center of the groove 721, and the substrate 712 on which the fingerprint sensor 711 is mounted may be supported by the supporting units 723. A pair of supporting units 723 may be disposed to stably support the substrate 712.

Light-emitting units 714 may be disposed on a lower surface 713 of the substrate 712. All of the content related to the light-emitting unit of the first exemplary embodiment described above may be applied to the light-emitting units 714.

The reflective part 724 may be disposed in an inner surface of the groove 721. The reflective part 724 may be disposed by vapor deposition, printing, spraying, plating, or the like. For example, the reflective part 724 may be formed by being coated with a solution having a reflective function or may be formed by being coated with a reflective film. Therefore, light emitted from the light-emitting units 714 which are disposed on the lower surface 713 of the substrate 712 may be reflected by the reflective part 724. In addition, the reflective part 724 may be configured to enable light to be completely reflected.

Further, the through part 725 may be disposed at a center of the base 720 and a connector 715 may be mounted on a center of the lower surface 713 of the substrate 712. The connector 715 may be exposed to the outside of the fingerprint sensor module 710 through the through part 725 and may be electrically connected to a main substrate (not illustrated) disposed in an electronic device.

The cover 730 may cover an upper surface of the base 720 and fix the fingerprint sensor 711.

The cover 730 may have an opening 731 formed therethrough. The fingerprint sensor 711 may be coupled to the opening 731, and a sensing unit (not illustrated) may be exposed through the opening 731.

A fixing unit 733 may be disposed to protrude from a lower surface 732 of the cover 730, and the substrate 712 may be disposed at and fixed to the inside of the fixing unit 733.

The cover 730 may be made from a light-transmitting material, and thus light emitted from the light-emitting unit 714 may be transmitted through the cover 730.

A light-shielding unit 734 may be disposed on an upper surface of the cover 730, and the light-shielding unit 734 may block light. The light-shielding unit 734 may not be disposed in a part of an area of the upper surface of the cover 730. Here, the part of the area may be a band-shaped open area 735 spaced apart from the fingerprint sensor 711 by a predetermined distance and having a predetermined width along an edge of the fingerprint sensor 711.

The light-shielding unit 734 may be provided by vapor deposition, printing, spraying, plating, or the like. For example, the light-shielding unit 734 may be formed by being coated with a solution having a light blocking function, or may be formed by being coated with a film having a light blocking function.

Therefore, light which travels through the cover 730 may be emitted through the open area 735 disposed on the upper surface of the cover 730. The open area 735 may serve as an indicator as described above.

A thin coating layer (not illustrated) may also be disposed in the open area 735, and the coating layer may have a color.

Further, the coating layer may be formed to be thin enough to enable light to be transmitted through the cover 730. The color layer may express a color even when light is not emitted from the light-emitting unit 714, and thus a function of the indicator may be implemented even when light is not emitted from the light-emitting unit 714.

An adhesive 740 for adhering the base 720 to the cover 730 may be disposed between the upper surface 722 of the base 720 and the lower surface 732 of the cover 730. There is no limit on the type and form of the adhesive 740, and for example, a double-sided adhesive tape may be used.

Further, the fingerprint sensor module 710 may be coupled to a seating part 751 of a cover window 750. In the exemplary embodiment, a case in which the seating part 751 is formed to have a groove shape is described as an example. However, the following description may be equally applied to a case in which the seating part 751 is formed as a lower surface of the cover window 750 other than the case in which the seating part 751 is formed to have a groove shape.

An adhesion part 755 may be disposed between the fingerprint sensor module 710 and the seating part 751 to couple the fingerprint sensor module 710 and the seating part 751.

The adhesion part 755 may be disposed on the entire seating part 751 and may have light transmittance so that light emitted from the open area 735 of the cover 730 may be introduced into the cover window 750.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent

1. A fingerprint sensor module assembly integrated with a cover window for an electronic device, the fingerprint sensor module assembly comprising:
the cover window disposed on a front surface of the electronic device, configured to display an image generated from a display module on the cover window, and having a seating part disposed on a lower surface of the cover window;
a fingerprint sensor module comprising a fingerprint sensor having a sensing unit for sensing fingerprints and a substrate electrically connected to the fingerprint sensor, and coupled to the seating part; and
an adhesion part disposed between the seating part and the fingerprint sensor module and configured to fix the fingerprint sensor module to the seating part.

2. The fingerprint sensor module assembly of claim 1, wherein the seating part is disposed on the lower surface of the cover window and facing an inside of the electronic device.

3. The fingerprint sensor module assembly of claim 1, wherein the seating part is formed in a groove shape to correspond to a shape of the fingerprint sensor, and the fingerprint sensor is mounted on and fixed to the seating part.

4. The fingerprint sensor module assembly of claim 3, wherein the seating part is formed by an etching or cutting process.

5. The fingerprint sensor module assembly of claim 3, wherein the sensing unit and at least a part of the fingerprint sensor are disposed in the seating part.

6. The fingerprint sensor module assembly of claim 5, wherein at least a part of the substrate is additionally disposed in the seating part.

7. The fingerprint sensor module assembly of claim 3, wherein a thickness of the cover window between an upper surface of the cover window and an upper surface of the sensing unit ranges from 200 μm to 300 μm.

8. The fingerprint sensor module assembly of claim 1, wherein the cover window has a display area on which an image is displayed and a bezel area in which a print layer is disposed and an image is not displayed, and the seating part is disposed in the bezel area.

9. The fingerprint sensor module assembly of claim 1, wherein an engraved or embossed pattern is additionally disposed in an area corresponding to an upper side of the fingerprint sensor in the upper surface of the cover window which is exposed to a user.

10. The fingerprint sensor module assembly of claim 1, wherein an open area having a predetermined width is disposed along an edge of the seating part on the lower surface of the cover window, and a light-emitting unit is disposed under the cover window and configured to emit light toward the upper surface of the cover window through the open area.

11. The fingerprint sensor module assembly of claim 10, wherein at least one light-emitting unit is disposed on the substrate or a main substrate electrically connected to the fingerprint sensor module.

12. The fingerprint sensor module assembly of claim 1, wherein the cover window has a display area on which an image is displayed and a bezel area in which a print layer is disposed and an image is not displayed, and the seating part is disposed in the display area.

13. The fingerprint sensor module assembly of claim 1, wherein the cover window is made from a material selected from glass, sapphire, zirconium and a transparent resin.

14. The fingerprint sensor module assembly of claim 1, wherein the cover window further comprises a non-display part disposed independently of the cover window, and the seating part is disposed in the non-display part.

15. The fingerprint sensor module assembly of claim 14, wherein the non-display part is made from a resin or a metal material.

16. The fingerprint sensor module assembly of claim 1, wherein the cover window comprises:
a first cover window of which an upper surface is exposed to a user;
an adhesive layer disposed on a lower surface of the first cover window; and
a second cover window of which an upper surface is adhered to the lower surface of the first cover window by the adhesive layer,
wherein the seating part is disposed to pass through the second cover window.

17. The fingerprint sensor module assembly of claim 16, wherein a thickness of the second cover window corresponds to a height of the fingerprint sensor.

18. The fingerprint sensor module assembly of claim 1, wherein a color layer is disposed on a surface of the seating part and the adhesion part is disposed on the color layer.
